(19) United States
(12) Patent Application Publication
(10) Pub. No.: US 2015/0095069 A1
(43) Pub. Date: Apr. 2, 2015

(54) Algorithms to Identify Patients with Hepatocellular Carcinoma

(71) Applicant: THE REGENTS OF THE UNIVERSITY OF MICHIGAN, Ann Arbor, MI (US)

(72) Inventors: Akbar Waljee, Ann Arbor, MI (US); Ji Zhu, Ann Arbor, MI (US); Ashin Mukerjee, Ann Arbor, MI (US); Jorge Marrero, Ann Arbor, MI (US); Peter Higgins, Ann Arbor, MI (US); Amit Singal, Ann Arbor, MI (US)

(21) Appl. No.: 14/503,757

(22) Filed: Oct. 1, 2014

Related U.S. Application Data
(60) Provisional application No. 61/885,283, filed on Oct. 1, 2013.

(51) Int. Cl. G06F 19/00

(52) U.S. Cl. CPC G06F 19/3431; G06F 19/3443
USPC 705/3

(57) ABSTRACT

A method for identifying patients with a high risk of liver cancer development includes receiving patient data describing a plurality of patients and executing a patient identification module on the patient data to identify at least some of the plurality of patients as having a high risk of developing liver cancer. The patient identification module is generated based on an application of machine learning techniques to a training data set, and the patient identification module is validated based on both the training data set and an external validation data set. Further, the method includes generating a grouping of the plurality of patients based on the identification of the at least some of the plurality of patients.

### CROSS-REFERENCE TO RELATED APPLICATIONS

This application claims priority to U.S. Provisional Patent Application No. 61/885,283, filed on Oct. 1, 2013, and titled “ALGORITHMS TO IDENTIFY PATIENTS WITH HEPATOCELLULAR CARCINOMA,” the entire disclosure of which is hereby expressly incorporated by reference herein.

### TECHNICAL FIELD

The present disclosure generally relates to identifying patients at high risk for liver cancer and, more particularly, to a machine learning method for predicting patient outcomes.

### BACKGROUND

Currently, Hepatocellular carcinoma (HCC) is the third leading cause of cancer-related death worldwide and one of the leading causes of death among patients with cirrhosis. The incidence of HCC in the United States is increasing due to the current epidemic of hepatitis C virus (HCV) infection and non-alcoholic fatty liver disease (NAFLD). Prognosis for patients with HCC depends on tumor stage, with curative options available for patients diagnosed at an early stage. Patients with early HCC achieve five-year survival rates of seventy percent with resection or transplantation, whereas those with advanced HCC have a median survival of less than one year.

Frequently, surveillance methods use ultrasound with or without alpha fetoprotein (AFP) every six months to detect HCC at an early stage. Such methods are recommended in high-risk populations. However, one difficulty in developing an effective surveillance program is the accurate identification of a high-risk target population. Patients with cirrhosis are at particularly high risk for developing HCC, but this may not be uniform across all patients and etiologies of liver disease. Retrospective case-control studies have identified risk factors for HCC among patients with cirrhosis, such as older age, male gender, diabetes, and alcohol intake, and subsequent studies have developed predictive regression models for the development of HCC using several of these risk factors. However, these predictive models are limited by moderate accuracy, and none of the predictive models have been validated in independent cohorts.

### SUMMARY

In one embodiment, computer-implemented method comprises receiving, at a patient identification module via a network interface, patient data describing a plurality of patients, and identifying, by a patient identification module executing on one or more processors, at least some of the plurality of patients as having a high risk of developing liver cancer. The patient identification module is generated based on an application of machine learning techniques to a training data set, and the patient identification module is validated based on both the training data set and an external validation data set. The computer-implemented method further includes generating, by the patient identification module, a grouping of the plurality of patients based on the identification of the at least some of the plurality of patients.

In another embodiment, a computer device for identifying patients with a high risk of liver cancer development comprises one or more processors and one or more non-transitory memories coupled to the one or more processors. The one or more memories include computer executable instructions stored therein that, when executed by the one or more processors, cause the one or more processors to receive, via a network interface, patient data describing a plurality of patients, and execute a patient identification module on the patient data to identify at least some of the plurality of patients as having a high risk of developing liver cancer. The patient identification module is generated based on an application of machine learning techniques to a training data set, and The patient identification module is validated based on both the training data set and an external validation data set. Further, the computer executable instructions cause the one or more processors to generate a grouping of the plurality of patients based on the identification of the at least some of the plurality of patients.

### BRIEF DESCRIPTION OF THE DRAWINGS

FIG. 1 illustrates cumulative incidences of HCC development in an internal training data set;

FIG. 2 illustrates an example classification tree for HCC development.

FIG. 3 illustrates the importance of variables in an example outcome prediction module.

FIG. 4 is a summary table of results for an example outcome prediction module such as an outcome prediction module based on the variables illustrated in FIG. 3.

FIG. 5 is another summary table of results for an example outcome prediction module such as an outcome prediction module based on the variables illustrated in FIG. 3.

FIG. 6 is a flow diagram of an example method for identifying patients with a high risk of HCC development.

FIG. 7 is a block diagram of an example computing system that may implement the method of FIG. 6.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such terms should not be interpreted to be limited in scope based on any statement made in any section of this patent (other than the language of the claims). To the extent that any term recited in the claims at the end of this patent is referred to in this patent in a manner consistent with a single meaning, that is done for the sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

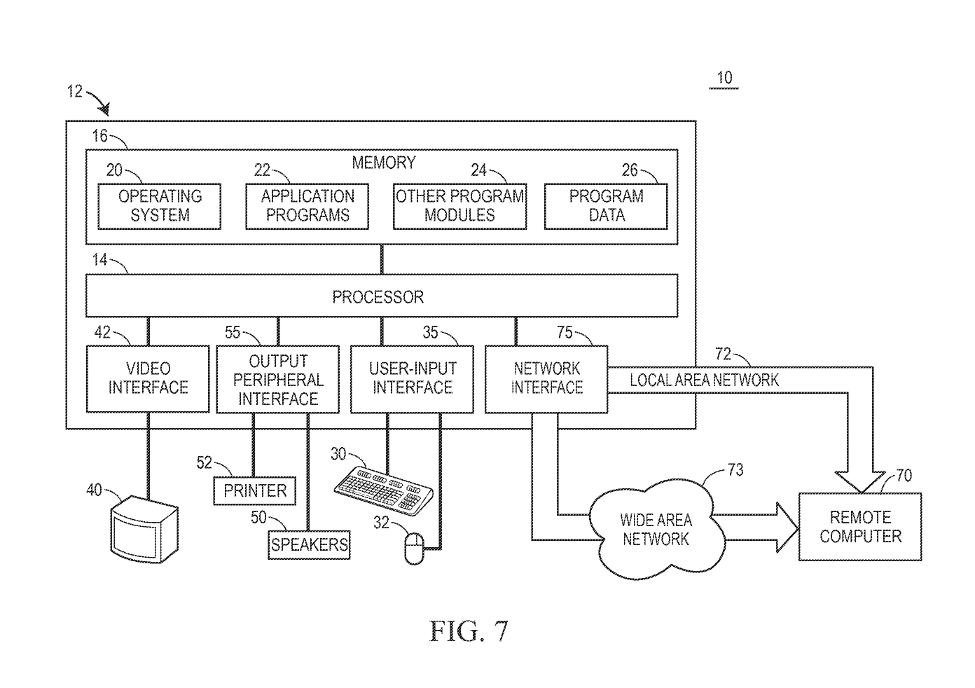

The techniques of the present disclosure may be utilized to identify patients at high risk for liver cancer, such as Hepatocellular Carcinoma (HCC), by executing a patient identification module with one of more processors of a computing device (see FIG. 7 for further discussion of an example computing device). As such, the patient identification module may allow clinicians to stratify patients with regard to their risk of HCC development.

In some implementations, the patient identification module may be both internally and externally validated. External validation may be an important aspect of the development of the algorithm, in some scenarios, given that the performance of regression models is often substantially higher in derivation (i.e., training) datasets than in validation sets. Further, given the marked heterogeneity among at-risk populations in terms of etiologies of liver disease, degree of liver dysfunction, and prevalence of other risk factors (such as diabetes, smoking or alcohol use), validation of any predictive model for HCC development is likely crucial.

In some implementations, health care providers or clinician may use the patient identification module as a basis for an electronic health record decision support tool to aid with real-time assessments of HCC risk and recommendations regarding HCC surveillance. For example, the patient identification module may identify high-risk individual cases and transmit annotated data back to a provider, thus facilitating changes to a clinical assessment. Moreover, the patient identification module may form the basis for a publicly available online HCC risk calculator.

Accurate assessment of HCC risk among patients with cirrhosis, via execution of patient identification module on patient data, may allow targeted application of HCC surveillance programs, in some implementations. High risk patients, as identified by the validated learning algorithms, may benefit from a relatively intense HCC surveillance regimen. Although surveillance with cross sectional imaging is not recommended among all patients with cirrhosis, such surveillance may be cost-effective among a subgroup of cirrhotic patients.

Moreover, in contrast to existing trends to use only static laboratory tests (e.g., test for AFP), the patient identification module of the present disclosure may account for and quantify the importance of both static variable values and temporal characteristics (e.g., base, mean, max, slope, and acceleration) of variables. Based on this quantification, the patient identification module may be refined (e.g., with machine learning techniques) to more efficiently and effectively identify high risk patients, in some implementations.

To generate, validate, and refine the patient identification module, a computing device (e.g., a server) may execute an algorithm generation engine in two phases. First, the algorithm generation engine may analyze a set of internal training data to generate an outcome prediction module and internally validate the outcome prediction module. Second, the algorithm generation engine may externally validate the outcome prediction routine to produce an internally and externally validated patient identification routine.

### Machine Learning and Internal Training Data

The algorithm generation engine may include machine learning components to identify patterns in large data sets and make predictions about future outcomes. For example, the algorithm generation engine may include neural network, support vector machine, and decision tree components. Specifically, a type of decision tree analysis called a random forest analysis may divide large groups of cases (e.g., within an internal training data set) into distinct outcomes (e.g. HCC or no HCC), with a goal of minimizing false positives and false negatives.

A random forest analysis, or other suitable machine learning approach, used to generate an outcome prediction module may have several characteristics in an implementation: (i) a lack of required hypotheses which may allow important but unexpected predictor variables to be identified; (ii) “out-of-bag” sampling which facilitates validation and reduces the risk of overfitting; (iv) consideration of all possible interactions between variables as potentially important interactions; and (v) requirement of minimal input from a statistician to develop a model. Further, machine learning models may easily incorporate new data to continually update and optimize algorithms, leading to improvements in predictive performance over time.

An internal training data set, used by the algorithm generation engine to generate an outcome prediction module, may include demographic, clinical, and laboratory training data. Demographics data may include variables such as age, gender, race, body mass index (BMI), past medical history, lifetime alcohol use, and lifetime tobacco use. Clinical data may include variables such as underlying etiology and a presence of ascites, encephalopathy, or esophageal varices, and laboratory data may include variables such as platelet count, aspartate aminotransferase (AST), alanine aminotransferase (ALT), alkaline phosphatase, bilirubin, albumin, international normalized ratio (INR), and AFP.

In general, a complete blood count may include any set of the following variables: hemoglobin, hematocrit, red blood cell count, white blood cell count, platelet count, mean cell volume (MCV), mean cell hemoglobin (MCH), mean cell hemoglobin concentration (MCHC), mean platelet volume (MPV), neutrophil count (NEUT), basophil (BASO) count, monocyte count (MONO), lymphocyte count (LYMPH), and eosinophil count (EOS). Also, chemistries may include any set of the following variables: aspartate aminotransferase (ASP), alanine aminotransferase (ALT), alkaline phosphatase (ALK), bilirubin (TBIL), calcium (CAL), albumin (ALB), sodium (SOD), potassium (POT), chloride (CHLOR), bicarbonate, blood urea nitrogen (UN), creatinine (CREAT), and glucose (GLUC).

The internal training data set may also include data about patients who underwent prospective evaluations over time. For example, the internal training data set may include data about patients who underwent evaluations every 6 to 12 months by physical examination, ultrasound, and AFP. If an AFP level was greater than 20 ng/mL or any mass lesion was seen on ultrasound, the data may also indicate triple-phase computed tomography (CT) or magnetic resonance imaging (MRI) data to further evaluate the presence of HCC. In this manner, outcome predication algorithms and the patient identification module may be at least partially based on temporal changes in variables.

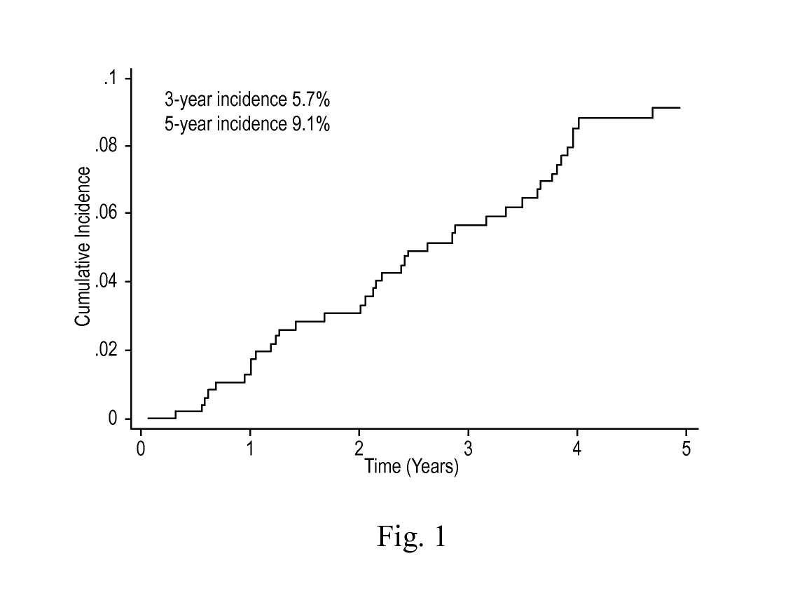

In one example scenario, an internal training set (referred to as the “Internal university training set”) includes 442 patients with cirrhosis but without prevalent HCC. The median age of the patients in the internal university training set is 52.8 years (range 23.6-82.4), and more than 90% of the patients are Caucasian. More than 58.6% of the patients are male, and the most common etiologies of cirrhosis in the internal university training set are hepatitis C (47.3%), cryptogenic (19.2%), and alcohol-induced liver disease (14.5%). A total of 42.9% patients in the internal university training set were Child Pugh class A and 52.5% were Child Pugh class B. Median Child Pugh and MELD scores at enrollment of patients in the internal university training set are 7 and 9, respectively. Median baseline AFP levels are 5.9 ng/mL in patients who developed HCC, and 3.7 ng/mL in patients who did not develop HCC during follow-up (p<0.01), in the example scenario. Median follow-up of the internal university training set is 3.5 years (range 0-6.6), with at least one year of follow-up in 392 (88.7%) patients. Over a 1454 person-year follow-up period, 41 patients with data in the internal university training set developed HCC for an annual incidence of 2.8% (see FIG. 1). The cumulative 3- and 5-year probability of HCC development is 5.7% and 9.1%, respectively. Of the 41 patients with HCC in the internal university training set, 4 (9.8%) tumors are classified as very early stage (BCLC stage 0) and 19 (46.3%) as BCLC stage A.

Although the above described internal university training set will be referred to below in reference to the generation and internal validation of outcome predication algorithms, it is understood that any suitable internal training set may be used to generate and validate outcome predication algorithms.

In general, several parameters may be measured to determine how well an outcome prediction module performs. Sensitivity is the proportion of true positive subjects (e.g., subjects with HCC) who are assigned a positive outcome by the outcome prediction model. Similarly, specificity is defined as the proportion of true negative subjects (e.g, subjects without HCC) who are assigned a negative outcome by the outcome prediction model. The Area Under the Receiver Operating Characteristic curve (AuROC) is another way of representing the overall accuracy of a test and ranges between 0 and 1.0, with an area of 0.5 representing test accuracy no better than chance alone. Higher AuROC indicates a better performance.

ROC curves are often helpful in diagnostic settings as the outcome is determined and can be compared to a gold standard. However, in general, any statistic may be used to access the effectiveness of an outcome prediction module. For example, a c-statistic may describe how well an outcome predication algorithm can rank cases and non-cases, but the c-statistic is not a function of actual predicted probabilities or the probability of the individual being classified correctly. This property makes the c-statistic a less accurate measure of the prediction error. Yet, in some implementations, an algorithm generation engine may generate an outcome predication algorithm such that the algorithm provides risk predictions with little change in the c-statistic. In addition, the overall performance of an outcome prediction model may be measured using a Brier score, which captures aspects of both calibration and discrimination. Brier scores can range from 0 to 1, with lower Brier scores being consistent with higher accuracy and better model performance.

### Random Forest

In some implementations, a computing device (e.g., a server) may execute an algorithm generation engine which includes a random forest analysis. The random forest analysis may identify baseline risk factors associated with the development of HCC in an internal cohort of patients with corresponding data in the internal training data set (e.g., the internal university training set), for example.

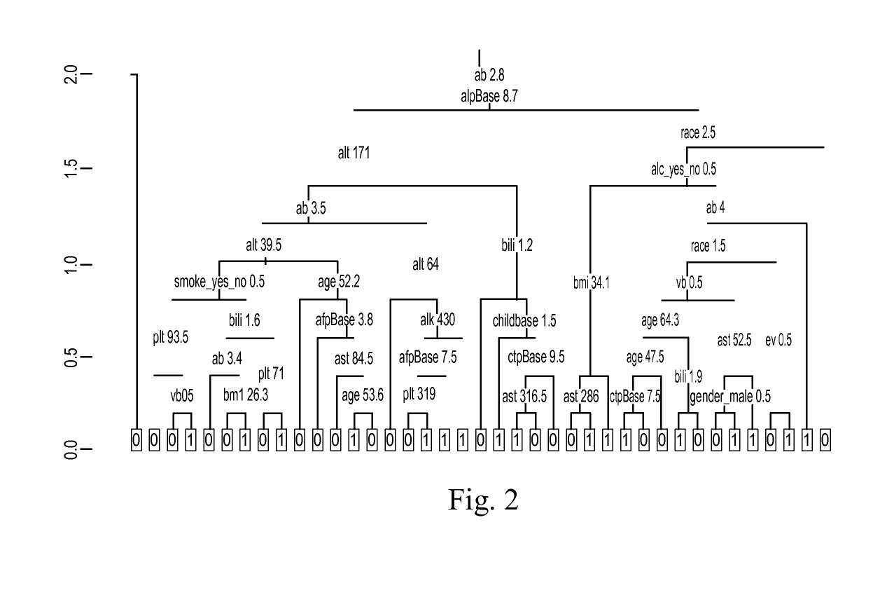

The random forest approach may divide the initial cohort into an “in-bag” sample and an “out-of-bag” sample. The algorithm generation engine may generate the in-bag sample using random sampling with replacement from the initial cohort, thus creating a sample equivalent in size to the initial cohort. A routine may then generate the out-of-bag sample using the unsampled data from the initial cohort. In some implementations, the out-of-bag sample includes about one-third of the initial cohort. The routine may perform this process a pre-determined number of times (e.g., five hundred times) to create multiple pairings of in-bag and out-of-bag samples. For each pairing, the routine may construct a decision tree based on the in-bag sample and using a random set of potential candidate variables for each split. Once a decision tree is generated, the routine may internally validate the tree using the out-of-bag sample. FIG. 2 includes an example decision tree based on an in-bag sample.

As each tree is generated, the routine may only consider a random subset of the predictor variables as possible splitters for each binary partitioning, in an implementation. The routine may use predictions from each tree as “votes”, and the outcome with the most votes is considered the dichotomous outcome prediction for that sample. Using such a process, the routine may construct multiple decision trees to create the final classification prediction model and determine overall variable importance.

The algorithm generation engine may calculate accuracies and error rates for each observation using the out-of-bag predictions and then average over all observations, in an implementation. Because the out-of-bag observations are not used in the fitting of the trees, the out-of-bag estimates serve as cross-validated accuracy estimates (i.e., for internal validation).

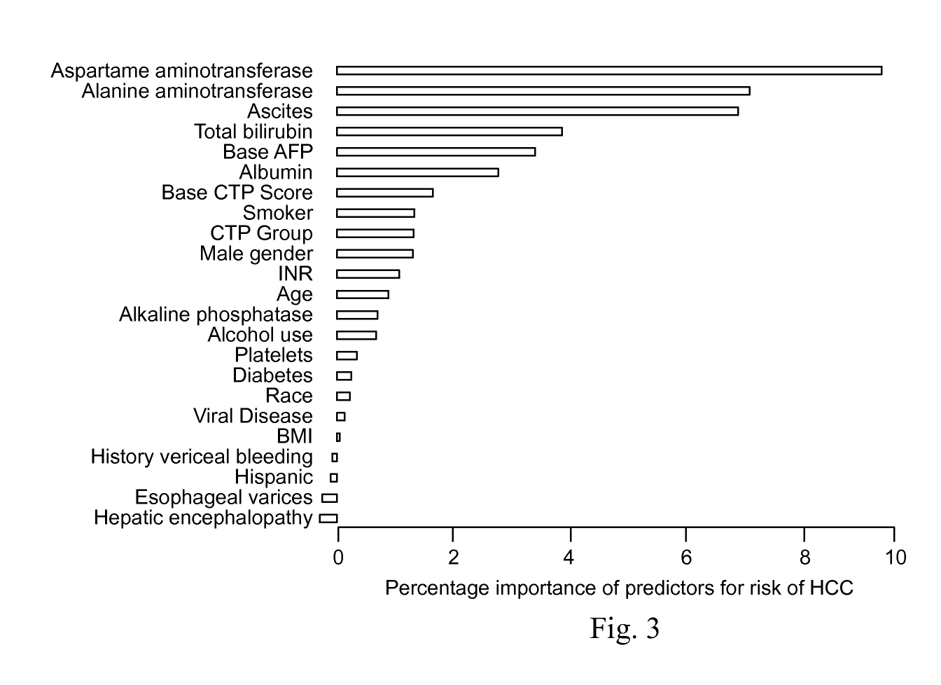

In some implementations, random forest modeling may produce algorithms that have similar variable importance results as other machine learning methods, such as boosted tree modeling, except with a greater AuROC in the internal training set. The effectiveness of the algorithm generated by the random forest model in predicting clinical response is illustrated in FIGS. 3-5. An example illustration of a proportional variable importance of each of the variables is shown in graph form in FIG. 3. In one scenario, the most important independent variables in differentiating patients who develop HCC and those without HCC were as follows: AST, ALT, the presence of ascites, bilirubin, baseline AFP level, and albumin.

It should be noted that the random forest machine learning approach, as well as any of the other sophisticated tree generating approaches (including boosted trees), may produce very complex algorithms (e.g., huge sets of if-then conditions) that can be applied to future cases with computer code. However, such a complex algorithm (e.g., with 10,000 or more decision trees) is difficult to illustrate in graphical form for inclusion in an application. Instead, the selection of variables used as inputs into any of the regression and classification tree techniques to generate an algorithm and/or the relative importance of the variables also uniquely identify the algorithm. Alternatively, a graph of variable importance percentages can be used to uniquely characterize each algorithm. In fact, both the ratio and the ranges of the variable importance percentages uniquely identify the set of decision trees or algorithms produced by the random forest model. For example, while only a subset of the total list of variables may be used in generating further algorithms, the ratios of relative importance between the remaining variables remains roughly the same, and can be gauged based on the values provided in a variable importance.

Any random forest tree generated according to a data set is suitable according to the present disclosure, but will be characterized by relative variable importance substantially the same as those displayed in FIG. 3. For example, if all of the variables depicted in FIG. 3 are used, the relative importance of each variable will be about the same proportion within a range of about twenty-five percent (either lower or higher). As another example, if only ten of the variables depicted in FIG. 3 are used, the relative importance of one variable to another (e.g. the ratio of the importance of one variable divided by the importance of the other variable) will remain substantially the same, where the ratios differ by only about 7%.

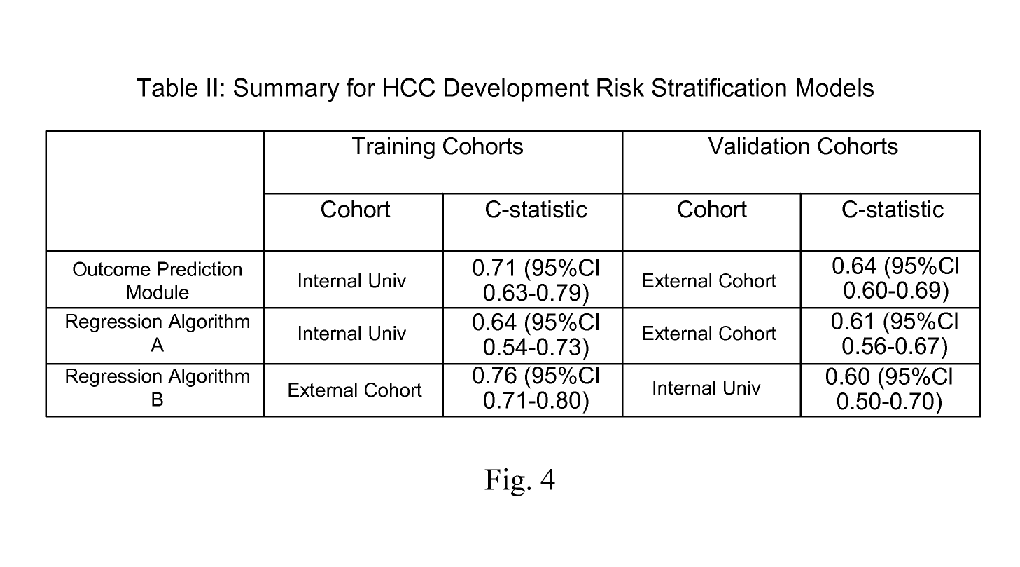

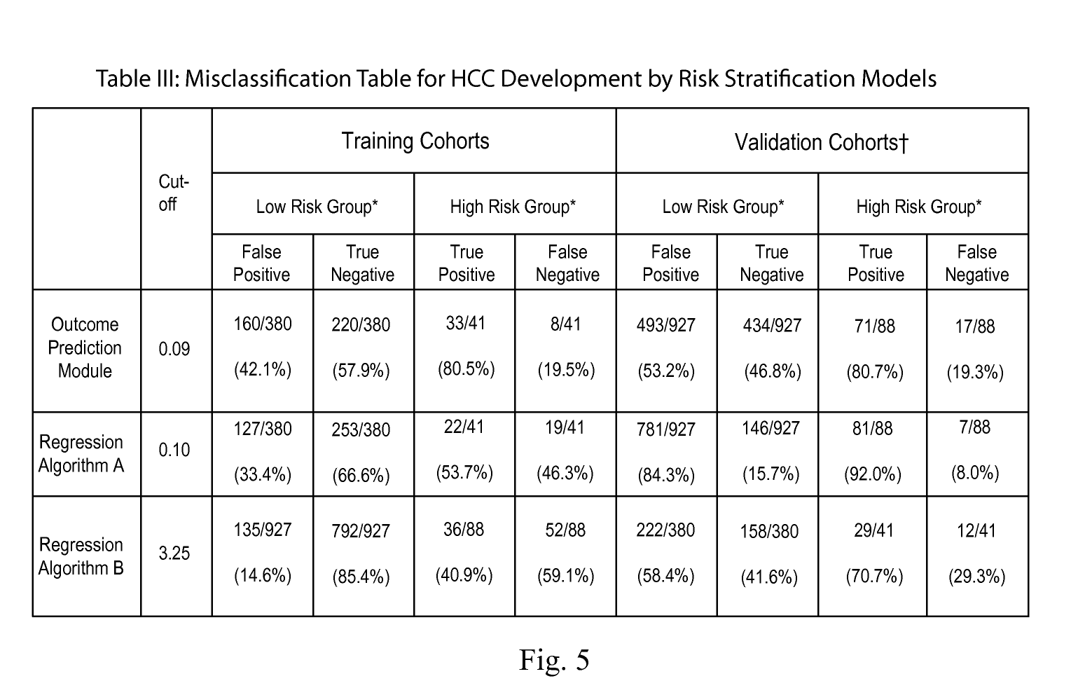

In one scenario, an outcome prediction module generated using random forest analysis has a c-statistic of 0.71 (95% Cl 0.63-0.79) in the internal university training set. Further, using a previously accepted cut-off of 3.25 to identify high-risk patients, the outcome predication algorithm has a sensitivity and specificity of 80.5% and 57.9%, respectively, in the internal university training set. In addition, the Brier scores for the outcome prediction module is 0.08 in the internal university training set, in the scenario. See FIGS. 4 and 5 for summaries of results for the outcome prediction module and two other existing regression models for comparison.

In some implementations, the outcome prediction module may be based both on fixed, or static, variables like AST, ALT, and longitudinal variables like weight, AFP, CTP, and MELD, to build a record for each patient (one row for each patient). The values associated with the longitudinal variables and used by the outcome prediction module may include the base, the mean, the max, the slope and the acceleration of the longitudinal variables. Based on the longitudinal variables, an outcome prediction module may include three kinds of models called baseline, predict-6-month, predict-12-month, in an implementation. The baseline model is associated with a final outcome, and the predict-6-month model is associated with the outcome within 6 months of the patient's last visit. Likewise, the predict-12-month model is associated with an outcome within 12 months of the patient's last visit.

### External Validation

In some implementations, the algorithm generation engine may externally validate an outcome prediction module to generate a both internally and externally validated patient identification module. Although, the outcome predication algorithm may not need separate external validation, as it is generated internally using the out-of-bag samples, the algorithm generation engine may still perform both out-of-bag internal validation (e.g., in the internal university training set) and external validation (e.g., in an external validation set).

For example, the algorithm generation engine may use several complementary types of analysis to assess different aspects of outcome prediction module performance with respect to an external validation data set. First, the algorithm generation engine may compare model discrimination for the outcome prediction module using receiver operating characteristic (ROC) curve analysis. The algorithm generation engine may then assess gain in diagnostic accuracy with the net reclassification improvement (NRI) statistic, using the Youden model, and the integrated discrimination improvement (IDI) statistic, in an implementation. Further, the algorithm generation engine may obtain risk thresholds in the outcome prediction module to maximize sensitivity and capture all patients with HCC.

Still further, using risk cut-offs to define a low-risk and high-risk group, the algorithm generation engine may assess the ability of the outcome prediction module to differentiate the risk of HCC development among low-risk and high-risk patients. Also, the algorithm generation engine may again assess the overall performance of the outcome prediction module using Brier scores and Hosmer-Lemeshow χ² goodness-of-fit test.

In general, the algorithm generation engine may use any suitable complementary types of analysis to assess aspects of outcome prediction module performance with respect to an external validation data set. As a result of these complimentary types of analysis, the algorithm generation engine may generate an both externally and internally validated patient identification module. Further, in some cases, the algorithm generation engine may refine an outcome predication algorithm (e.g., with machine learning techniques) based on assessments with respect to external validation data, thus producing a further refined patient identification module.

The complementary types of analysis discussed above and, in general, all or part of the algorithm generation engine may be implemented using any suitable statistical programming techniques and/or applications. For example, the algorithm generation engine may be implemented using the STATA statistical software and/or the R statistical package.

In one example scenario, an external validation data set (referred to as the “External cohort validation set”) includes data about 1050 patients, with a mean age of 50 years and 71% being male. Cirrhosis is present at baseline in 41% of patients, with all cirrhotic patients having Child-Pugh A disease. The mean baseline platelet count in the external cohort validation set was 159*10 9/L, with 18% of patients having a platelet count below 100*10 9/L. Also, the mean baseline AFP level was 17 ng/mL, with 19% of patients having AFP levels >20 ng/mL. Over a 6120 person-year follow-up period, 88 patients in the example external cohort validation set developed HCC. Of those patients who developed HCC, 19 (21.1%) tumors are classified as TNM stage T1 and 47 (52.2%) as TNM stage T2.

In the scenario, the algorithm generation engine validates an outcome prediction module to produce a internally and externally validated patient identification module. During validation, the outcome prediction module, generated using random forest analysis as discuss above, had a c-statistic of 0.64 (95% Cl 0.60-0.69). Further, the outcome prediction module is able to correctly identify 71 (80.7%) of the 88 patients who developed HCC, while still maintaining a specificity of 46.8%. The outcome prediction module also had a Brier score of 0.08 in the external cohort validation set. See FIGS. 4 and 5 for summaries of results for the outcome prediction module and two other existing regression models for comparison.

Also, after using four bin calibration to adjust for differences between the internal university training set and the external cohort validation set, the algorithm generation engine may evaluate model calibration using the Hosmer-Lemeshow χ² goodness-of-fit test, in the example scenario. Such a test may be used to evaluate the agreement between predicted and observed outcomes, in an implementation. A significant value for the Hosmer-Lemeshow statistic indicates a significant deviation between predicted and observed outcomes. In the example scenario discussed above, the Hosmer-Lemeshow statistic was not significant for the outcome predication algorithm.

The algorithm generation engine may utilize the results of a validation, such as in the example scenario above, to further refine the outcome prediction module, or the algorithm generation engine may output the outcome prediction module as an internally and externally validated patient identification module. Subsequently, clinicians may utilize the patient identification module to identify newly encountered patients with a high risk for HCC.

### Identifying High Risk Patients

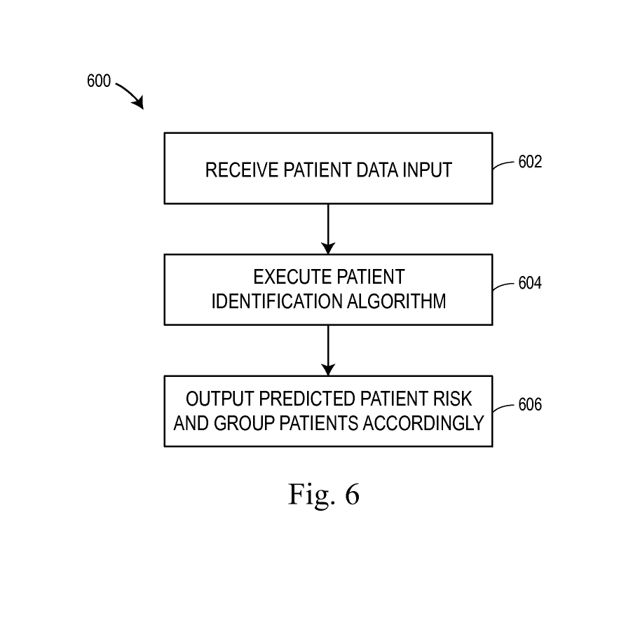

FIG. 6 is a flow diagram of an example method 600 for applying a patient identification module to identify risk (e.g., of HCC) associated with a patient. The method may be implemented by a computing device or system such as the computing system 10 illustrated in FIG. 7, for example.

To begin, data about a patient is received (block 602). For example, a computing device may receive data about a patient from a clinician operating a remote computer (e.g., laptop, desktop, or tablet computer). The data may be received by the computing device according to any appropriate format and protocol, such as the Hypertext Transfer Protocol (HTTP).

The data about the patient (i.e., “patient data”) may include at least some of the variables illustrated in FIG. 3, in an implementation. For example, the data about the patient may include AST, ALT, and the presence of ascites, bilirubin, baseline AFP level, and albumin. In general, the data about the patient may include any data related to the development of HCC, and the data about the patient may vary in amount and/or type from patient to patient. Further, the patient data may include data about only one patient, such that a risk of HCC may be predicted for a specific patient, or the patient data may include data about multiple patients, such that patient risks may be prioritized or ranked.

Next, a patient identification module, such as the internally and externally validated patient identification module described above, is executed. In some cases, the patient identification module is flexible and dynamic allowing a execution based on any amount and/or type of patient data received at block 602. Such flexibility may arise from the patient identification module basis in machine learning techniques, such as random forest analysis.

In some implementations, execution of the patient identification module may be at least partially directed to the analysis of temporal variables. For example, means, maxes, averages, slopes, accelerations, etc. of input variables (e.g., longitudinal variables) may be calculated and utilized to determine the patient's risk of developing HCC. In some implementations, the patient identification module may execute a variety of models or modules. For example, the patient identification module may execute a variety of models to predict outcomes at a respective variety of times, such as a current time, six months from the last patient visit, etc.

Then, at block 606, one or more outcome predictions is output as a result of executing the patient identification module. In some implementations, the outcome predications are output as a grouping a cirrhotic patients into groups of high risk patients and low risk patients. However, it is understood that any suitable grouping may be output from the patient identification module. For example, the outcome predications from the patient identification module may include a grouping of patients into groups of high risk patients, medium risk patients, low risk patients, short term risk patients, long term risk patients, etc. Alternatively, the outcome predictions may include numerical data representing relative risk scores, probabilities, or other numerical representations of risk.

In this manner, the patient identification module may be utilized by clinicians to identify cirrhotic patients at high risk for HCC development. Further, the patient identification module may be utilized to risk stratify patients with cirrhosis regarding their risk of HCC development.

### Computer Implementation

The algorithm generation engine, the outcome prediction module, and the internally and externally validated patient identification module may be implemented as components of a computing device such as that illustrated in FIG. 7. Generally, FIG. 7 illustrates an example of a computing system 10 that is specially configured to identify patients at high risk for liver cancer. It should be noted that the computing system 10 is only one example of a suitable computing system. Other computing systems (e.g., having different arrangements and combinations of components) may be specially configured to implement an algorithm generation engine, an outcome prediction module, and an internally and externally validated patient identification module, where the algorithm generation engine, the outcome prediction module, and the internally and externally validated patient identification module are specialized components of the computing system configured to allow the computing system to identify patients at high risk for liver cancer.

With reference to FIG. 7, an exemplary computing system 10 includes a computing device in the form of a computer 12. Components of computer 12 may include, but are not limited to, one or more processing units 14 and a system memory 16. The computer 12 may operate in a networked environment using logical connections to one or more remote computers, such as a remote computer 70, via a local area network (LAN) 72 and/or a wide area network (WAN) 73 via a modem or other network interface 75.

Computer 12 typically includes a variety of computer readable media that may be any available media that may be accessed by computer 12 and includes both volatile and nonvolatile media, removable and non-removable media. The system memory 16 includes non-transitory computer storage media, such as read only memory (ROM) and random access memory (RAM). The ROM may include a basic input/output system (BIOS). RAM typically contains data and/or program modules that include an operating system 20. The system memory may also store specialized module, programs, and engines such as an algorithm generation engine 22, an outcome prediction module 24, and an internally and externally validated patient identification module 26. The computer 12 may also include other removable/non-removable, volatile/nonvolatile computer storage media such as a hard disk drive, a magnetic disk drive that reads from or writes to a magnetic disk, and an optical disk drive that reads from or writes to an optical disk.

A user may enter commands and information into the computer 12 through input devices such as a keyboard 30 and pointing device 32, commonly referred to as a mouse, trackball or touch pad. Other input devices (not illustrated) may include a microphone, joystick, game pad, satellite dish, scanner, or the like. These and other input devices are often connected to the processing unit 14 through a user input interface 35 that is coupled to a system bus, but may be connected by other interface and bus structures, such as a parallel port, game port or a universal serial bus (USB). A monitor 40 or other type of display device may also be connected to the processor 14 via an interface, such as a video interface 42. In addition to the monitor, computers may also include other peripheral output devices such as speakers 50 and printer 52, which may be connected through an output peripheral interface 55.

Generally, tree classification models, such as random forest models, utilized by the algorithm generation engine 22, the outcome prediction module 24, and/or the internally and externally validated patient identification module 26 may be configured according to the R language (a statistical programming language developed and distributed by the GNU system) or another suitable computing language for execution on computer 12. When utilized, such a model (e.g., random forest) may be executed on observed data, such as the training set of patient results indicating clinical response and values for blood counts, blood chemistry, and patient age. This observed data may be loaded, transmitted, and/or stored on to any of the computer storage devices of computer 12 to generate an appropriate tree algorithm (e.g., using boosted trees or random forest). Once generated (e.g., by the algorithm generation engine 22), the tree algorithm or other model, which may take the form of a large set of if-then conditions, may be configured using the same or different computing language for test implementation (e.g., as the outcome prediction module 24). For example, the if-then conditions may be specially configured using the C/C++ computing language and compiled to produce a module (e.g., the outcome prediction module 24), which, when run, accepts new patient data and outputs a calculated prediction or grouping of HCC risk. The output of the module may be displayed on a display (e.g., a monitor 40) or sent to a printer 52. The output may be in the form of a graph or table indicating the prediction or probability value along with related statistical indicators.

We claim:

1. A computer-implemented method comprising:
receiving, at a patient identification module via a network interface, patient data describing a plurality of patients;
identifying, by a patient identification module executing on one or more processors, at least some of the plurality of patients as having a high risk of developing liver cancer,
wherein the patient identification module is generated based on an application of machine learning techniques to a training data set, and
wherein the patient identification module is validated based on both the training data set and an external validation data set; and
generating, by the patient identification module, a grouping of the plurality of patients based on the identification of the at least some of the plurality of patients.

2. The computer-implemented method of claim 1, further comprising:
transmitting, by the patient identification module, an indication of the grouping of the plurality of patients to a remote computer device.

3. The computer-implemented method of claim 1, wherein the grouping of the plurality of patients includes forming a group of patients with a high risk of liver cancer development and a group of patients with a low risk of liver cancer development.

4. The computer-implemented method of claim 1, wherein the machine learning techniques include a random forest analysis.

5. The computer-implemented method of claim 1, wherein the patient data includes indications of age, gender, race, body mass index (BMI), past medical history, lifetime alcohol use, and lifetime tobacco use.

6. The computer-implemented method of claim 1, wherein the patient data includes indications of underlying etiology and a presence of ascites, encephalopathy, and esophageal varices.

7. The computer-implemented method of claim 1, wherein the patient data includes indications of platelet count, aspartate aminotransferase (AST), alanine aminotransferase (ALT), alkaline phosphatase, bilirubin, albumin, international normalized ratio (INR), and AFP.

8. The computer-implemented method of claim 1, wherein the patient data, the training data set, and the external validation data set each include indications of at least three of age, gender, race, body mass index (BMI), past medical history, lifetime alcohol use, lifetime tobacco use, underlying etiology, presence of ascites, presence of encephalopathy, presence of esophageal varices, platelet count, aspartate aminotransferase (AST), alanine aminotransferase (ALT), alkaline phosphatase, bilirubin, albumin, international normalized ratio (INR), and AFP.

9. The computer-implemented method of claim 8, wherein the application of machine learning techniques to the training data set includes generating a variable importance ranking of variables in the training data set.

10. The computer-implemented method of claim 9, wherein the most important variables in the variable importance ranking are, in order of most important to least important, AST, ALT, the presence of ascites, the presence of bilirubin, baseline AFP level, and albumin.

11. The computer-implemented method of claim 9, wherein the most important variables in the variable importance ranking are, in order of most important to least important, AST, ALT, and the presence of ascites.

12. The computer-implemented method of claim 9, wherein the most important variable in the variable importance ranking is AST.

13. The computer-implemented method of claim 1, wherein the application of machine learning techniques to the training data set includes quantifying an importance of longitudinal variables.

14. The computer-implemented method of claim 13, wherein the longitudinal variables are represented by at least one of a maximum, mean, minimum, baseline, slope, and acceleration.

15. The computer-implemented method of claim 13, wherein the identification of the at least some of the plurality of patients is based at least partially on temporal models and wherein the temporal models utilize the longitudinal variables.

16. A computer device specially configured to identify patients with a high risk of liver cancer development, the computer device comprising:
one or more processors; and
one or more non-transitory memories coupled to the one or more processors;
wherein the one or more memories include computer executable instructions stored therein that, when executed by the one or more processors, cause the one or more processors to:
receive, via a network interface, patient data describing a plurality of patients,
execute a patient identification module on the patient data to identify at least some of the plurality of patients as having a high risk of developing liver cancer,
wherein the patient identification module is generated based on an application of machine learning techniques to a training data set, and
wherein the patient identification module is validated based on both the training data set and an external validation data set, and
generate a grouping of the plurality of patients based on the identification of the at least some of the plurality of patients.

17. The computer device of claim 16, wherein the patient data, the training data set, and the external validation data set each include indications of at least three of age, gender, race, body mass index (BMI), past medical history, lifetime alcohol use, lifetime tobacco use, underlying etiology, presence of ascites, presence of encephalopathy, presence of esophageal varices, platelet count, aspartate aminotransferase (AST), alanine aminotransferase (ALT), alkaline phosphatase, bilirubin, albumin, international normalized ratio (INR), and AFP.

18. The computer-implemented method of claim 17, wherein the application of machine learning techniques to the training data set includes generating a variable importance ranking of variables in the training data set.

19. The computer-implemented method of claim 18, wherein the most important variable in the variable importance ranking is AST.

20. The computer-implemented method of claim 16, wherein the computer executable instructions further cause the one or more processors to:
send, via the network interface, an indication of the grouping of the plurality of patients to a remote computer device.
